(19) United States
(12) Patent Application Publication
(10) Pub. No.: US 2020/0283265 A1
(43) Pub. Date: Sep. 10, 2020

(54) DEVICE FOR CARRYING OUT MAINTENANCE WORK IN AN ELEVATOR SHAFT

(71) Applicant: Inventio AG, Hergiswil (CH)

(72) Inventors: Damien Baeriswyl, Luzern (CH); Ernst Huwiler, Malters (CH); Flavio Greissinger, Küssnacht (CH); Marcel Ulmi, Kriens (CH); Samuel Ruckstuhl, Pfaffnau (CH)

(21) Appl. No.: 16/649,817

(22) PCT Filed: Oct. 4, 2018
(86) PCT No.: PCT/EP2018/077008

§ 371 Date: Mar. 23, 2020

(30) Foreign Application Priority Data
Oct. 31, 2017 (EP) 17199429.6

(51) Int. Cl. B66B 5/00; B66B 5/28

(52) U.S. Cl. CPC B66B 5/0056; B66B 5/28

(57) ABSTRACT

An elevator system includes an elevator shaft, an elevator car and a counterweight being coupled and being arranged in the elevator shaft for movement in opposite directions, and a buffer device arranged in a shaft pit of the elevator shaft. The buffer device limits the travel path of the counterweight and includes a buffer and a lifting device, wherein in an idle position of the lifting device an overtravel of the elevator car in a shaft head of the elevator shaft is enabled. The lifting device can be activated to an active position to limit the travel path of the counterweight and, between a shaft ceiling of the elevator shaft and the elevator car, a minimum distance for maintenance by personnel can be ensured. The lifting device is arranged between the buffer and the counterweight.

### FIELD

The invention relates to a device for carrying out maintenance work in an elevator shaft and an elevator system comprising a device of this kind.

### BACKGROUND

Elevator systems comprise a large number of components arranged in an elevator shaft that have a specific service life. These components are regularly serviced in accordance with existing general or in-house regulations. There is therefore a need for service technicians to perform maintenance tasks in an elevator shaft. A large number of these maintenance tasks have to be carried out from the roof of an elevator car. In order to ensure the safety of the service technicians on the roof of the elevator car, a minimum distance between the elevator car and the upper shaft ceiling must be maintained. Additional structural measures are required in particular in elevator cars which, when arranged at the uppermost shaft door of an elevator shaft, are at a distance from the shaft ceiling that is too small for this purpose.

EP 1 052 212 A1 discloses an elevator system comprising a buffer device. The buffer device limits the travel of the counterweight in the elevator shaft in such a way that the elevator car can only reach an uppermost position in the elevator shaft that does not endanger a service technician on the elevator car. When accordingly designing the device, it is disadvantageous that a lifting device provided specifically for this elevator system has to be provided for every elevator system.

The problem addressed by the invention is therefore that of providing a modified device for carrying out maintenance work which can be used within different elevator systems.

### SUMMARY

This problem is solved by means of an elevator system comprising an elevator shaft, an elevator car and a counterweight, the elevator car and the counterweight being coupled and being arranged in the elevator shaft so as to be movable in opposite directions, and a buffer device arranged in a shaft pit of the elevator shaft, which buffer device limits the travel path of the counterweight and which buffer device comprises a buffer and a lifting device, overtravel of the elevator car in a shaft head of the elevator shaft being made possible in a rest position of the lifting device and it being possible to activate the lifting device such that, in an active position of the lifting device, the travel path of the counterweight in the shaft pit is restricted and a minimum distance for maintenance by personnel can be ensured between a shaft ceiling of the elevator shaft and the elevator car, characterized in that the lifting device is arranged between the buffer and counterweight.

The overtravel of the elevator car, which is made possible in the rest position of the lifting device, is limited by the buffer device acting on the counterweight due to the elevator car being coupled to the counterweight. Overtravel of this kind occurs when the bottom of the elevator car is arranged higher than the level of the highest floor. Overtravel of this kind is prevented in the active position of the lifting device. When the lifting device is in the rest position, the buffer device allows an unrestricted travel path of the counterweight and also of the elevator car, which travel path is restricted by the lifting device in the active position.

Buffers are usually used to place the counterweight or elevator car directly on the buffer. In this case, the movement of the counterweight or the elevator car is dampened directly by the buffer when necessary. This damping is achieved by the buffer being flexible in the vertical direction. In order to achieve this flexibility of the buffer, the buffer can substantially comprise a resilient component, for example a polyurethane block or a spring.

The invention is based on the knowledge that an elevator system of this kind comprising a lifting device, in which system the buffer directly limits the travel path of the counterweight, i.e. the buffer is arranged between the lifting device and the counterweight, leads to different designs of this lifting device when using lifting devices in different elevator systems. This is due to the use of different buffers which are arranged below the counterweight of the relevant elevator system. Contrary to previously customary practice, the buffer has not been arranged directly below the counterweight or below the elevator car. in order to minimize the design effort for lifting devices of this kind used in different elevator systems and accordingly produce a single design of the lifting device for a number of different elevator systems.

In one embodiment of the device, the elevator system has a bearing seat positioned on the buffer and a height-adjustable support. Fixed positioning of the bearing seat on the buffer is advantageous.

One embodiment of the elevator system comprises at least one guide rail for guiding the counterweight, wherein the height-adjustable support has a guide device for guiding the support on the guide rail. Irrespective of the load on the buffer device, proper positioning of the height-adjustable support can be guaranteed in this way.

In one embodiment of the elevator system, the bearing seat and the support are connected by at least one support arm. The bearing seat can be spaced apart from the support by means of a support arm of this kind.

In one embodiment of the elevator system, the lifting device has an activation element connected to the support arm, which activation element causes the lifting device to move from the rest position into the active position. This can simplify manual movement of the lifting device into its active position.

This activation element can be connected to the bearing seat or to the support or to a further activation element. A connection of this kind causes a relative movement of the components of the lifting device that can be moved relative to one another in order to move said lifting device into its active position.

This activation element can be formed by a spring. A spring of this kind is a simple and low-maintenance option for designing an activation element of this kind.

### DESCRIPTION OF THE DRAWINGS

The invention is explained in greater detail in the following with reference to drawings, in which:

FIG. 1 shows an elevator system comprising a buffer device which comprises a lifting device;

FIG. 2 shows the buffer device shown in FIG. 1;

FIG. 3 shows the buffer device shown in FIGS. 1 and 2 in an active position;

FIG. 4 shows a support of the lifting device shown in the previous figures; and

FIG. 5 shows a detail of the support of the lifting device.

### DETAILED DESCRIPTION

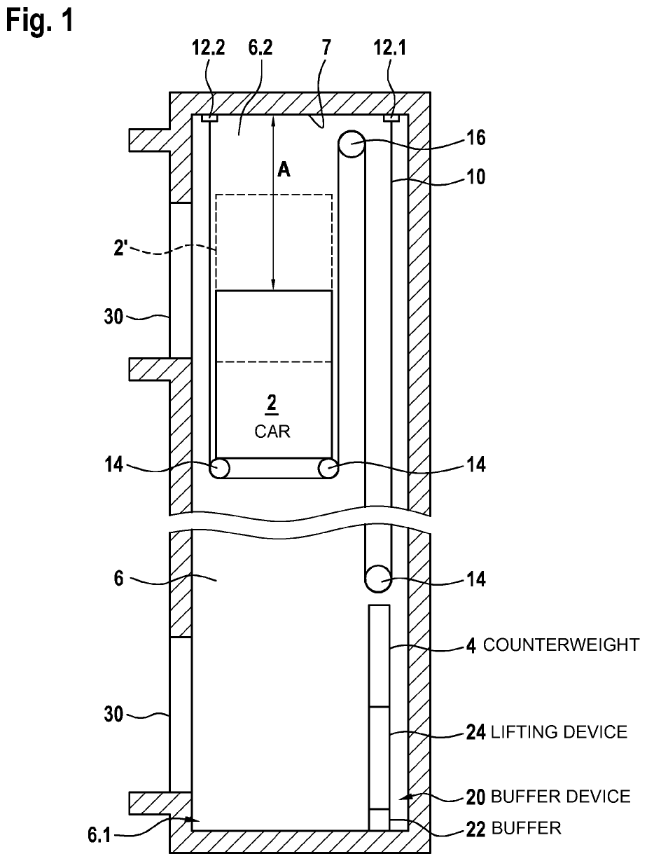

FIG. 1 shows an elevator system comprising a buffer device 20. The elevator system comprises an elevator shaft 6. An elevator car 2 is movably arranged within this elevator shaft 6. The elevator car 2 is coupled to a counterweight 4 by means of a suspension element 10. For example, the suspension element 10 is fixed, at its first end 12.1, to the shaft ceiling 7 of the elevator shaft 6. A second end 12.2 of the suspension element 10 is also fixed to the shaft ceiling 7. The suspension element 10 is deflected within the elevator shaft 6 by means of rollers 14, 16 such that the elevator car 2 can be moved in the opposite direction to the counterweight 4. For example, the roller 16 can be designed as a drive roller coupled to a drive motor.

The elevator shaft 6 has door openings 30 arranged on individual floors. A passenger located on one of the floors can enter the elevator car 2 through these door openings 30 when the elevator car 2 is arranged at this floor. The elevator shaft 6 has a shaft pit 6.1 and a shaft head 6.2. The elevator shaft 6 is delimited at its upper end or at the shaft head 6.2 by a shaft ceiling 7. The buffer device 20 is arranged below the counterweight 4 in the shaft pit 6.1. The buffer device 20 comprises a lifting device 24 and a buffer 22. The lifting device 24 can be transferred out of a rest position into an active position. In its rest position, the lifting device 24 is arranged such that the elevator car 2 can be moved to the uppermost floor during normal operation without the counterweight 4 being placed on the buffer device 20. The uppermost positioning of the elevator car 2 in normal operation that is possible according to this definition of the rest position of the lifting device 24 is illustrated in FIG. 1 by means of position 2′.

When the lifting device 24 is in the active position shown in FIG. 1, this described uppermost position of the elevator car 2, 2′ is not possible, since the travel path of the counterweight 4 and thus the travel path of the elevator car 2 coupled to the counterweight 4 is restricted. The lifting device 24 or buffer device 20 arranged in the active position thus brings about a non-minimizable distance A between the shaft ceiling 7 and the elevator car 2 in the shaft head 6.2. This distance A ensured by the buffer device 20 allows a service technician to carry out maintenance work on the elevator car 2 without being endangered by the elevator car 2 moving in the direction of the shaft ceiling 7.

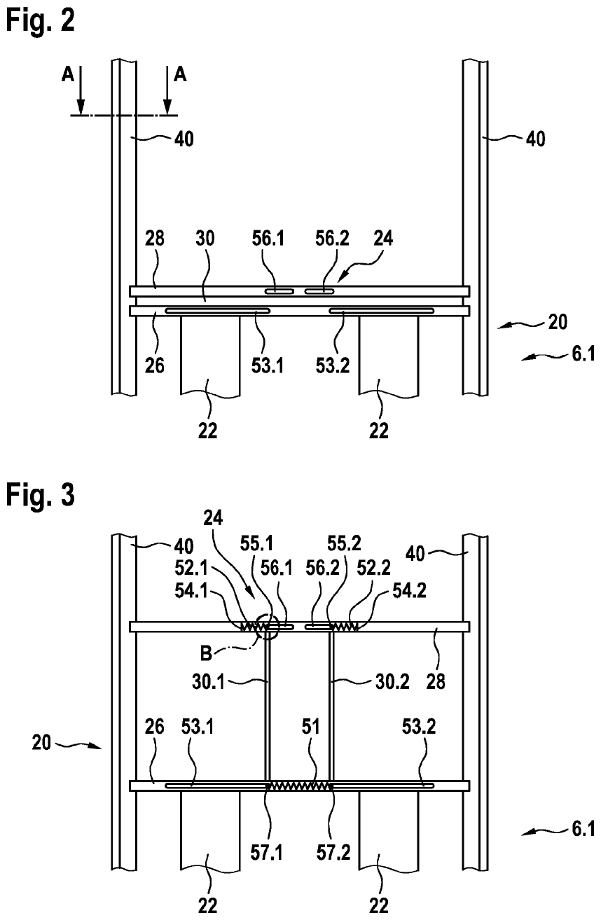

FIG. 2 shows the buffer device 20 in a shaft pit 6.1 of an elevator system which is shown by way of example in FIG. 1. In addition to the components of the elevator system shown in FIG. 1, two guide rails 40 for guiding the counterweight 4 are shown. In the shaft pit 6.1, the buffer device 20 is arranged at the lower end of the travel path of the counterweight. This means that the buffer device 20 limits the travel path of the counterweight. The guide rail 40 usually extends to the bottom of the shaft. As a result, the buffer device 20 can be arranged between the guide rails 40.

Independently of the buffer device 20 limiting the travel path of the counterweight, the travel path of the counterweight can be limited by further components of the elevator system before the counterweight is stopped by the buffer device 20 or before the counterweight directly abuts the buffer device 20. A component of this kind which limits the travel path of the counterweight can be formed, for example, by a safety circuit which, when activated, stops the counterweight and thus also the elevator car coupled to the counterweight in a position which corresponds to this safety circuit.

The buffer device 20 comprises a lifting device 24 and at least one buffer 22 which is arranged on the bottom of the shaft. The lifting device 24 is arranged above the buffer 22, i.e. between the counterweight and the buffer 22. The lifting device 24 comprises a bearing seat 26 and a height-adjustable support 28, wherein the bearing seat 26 and the height-adjustable support 28 can be connected by means of at least one indicated support arm 30.

The bearing seat 26 and/or the height-adjustable support 28 can have opening grooves 53.1, 53.2, 56.1, 56.2. These opening grooves 53.1, 53.2, 56.1, 56.2 can be arranged so as to guide the ends of the support arm 30 in the height-adjustable support 28 or in the bearing seat 26 when the lifting device 24 moves out of its rest position into its active position (and vice versa).

FIG. 3 shows the buffer device 20 shown in FIG. 2, the lifting device 24 being shown in its active position. Optionally, the lifting device 24 can have a second support arm 30.1, 30.2. In accordance with this active position, the support arms 30.1, 30.2 are arranged such that the bearing seat 26 and the height-adjustable support 28 are spaced apart from one another at a maximum distance.

In order to allow or facilitate movement of the lifting device 24 out of the active position into the rest position, one or each of the support arms 30.1, 30.2 can have guide elements 55.1, 55.2, 57.1, 57.2 on its ends. These guide elements 55.1, 55.2, 57.1, 57.2 are designed to slide or roll along the opening grooves 53.1, 53.2, 56.1, 56.2, for example, during this movement of the lifting device 24.

Moreover, the lifting device 24 can have one or more activation elements 51, 52.1, 52.2 which are designed to facilitate movement of the lifting device 24 out of its rest position into its active position. For example, one or more of these activation elements 51, 52.1, 52.2 can be designed as springs. At its first end, an activation element 51, 52.1, 52.2 of this kind can be connected, in the region of the guide element 55.1, 55.2, 57.1, 57.2, to the first support arm 30.1, 30.2 assigned to this guide element 55.1, 55.2, 57.1, 57.2. At its second end, this activation element 51, 52.1, 52.2 can be fixed to a fastening point 54.1, 54.2, which fastening point 54.1, 54.2 is fixed or arranged on the height-adjustable support 28. Instead of the embodiment shown in FIG. 3, the fastening point can be fixed or arranged on the bearing seat 26. Alternatively, the second end of the activation element 51, 52.1, 52.2 can be connected to the second support arm 30.1, 30.2 in the region of the guide element 57.1, 57.2.

Alternatively, the activation element(s) 51, 52.1, 52.2 can be connected to the at least one support arm 30.1, 30.2 or to the bearing seat 26 such that said activation element(s) 51, 52.1, 52.2 allow facilitated movement of the lifting device 24 out of its active position into its rest position.

Alternatively to the mounting of the support arms 30.1, 30.2 on the bearing seat 26 and on the support 28 that is shown in FIG. 3, the at least one support arm 30.1, 30.2 can be pivotably mounted on the bearing seat 26 and pivotably mounted on the height-adjustable support 28. This renders the guide elements 55.1, 55.2, 57.1, 57.2 and opening grooves 53.1, 53.2, 56.1, 56.2 shown unnecessary. Each of the at least one support arm(s) therefore comprises at least two elements, a first of these two elements being pivotably mounted on the support 28 and the second of the elements being pivotably mounted on the bearing seat 26. The two elements associated with a single support arm 30.1, 30.2 are pivotably interconnected.

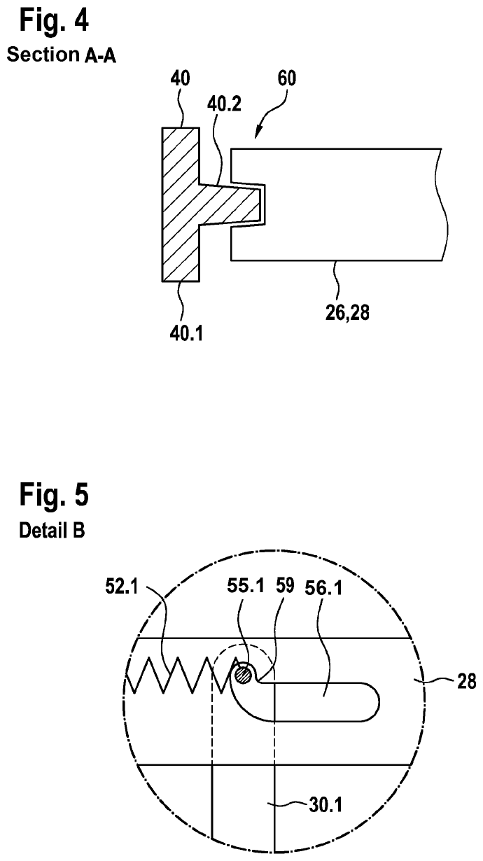

FIG. 4 shows the detail according to the cross-sectional line A-A of the lifting device 24 that is indicated in FIG. 2 and a guide rail 40 for guiding the counterweight. The bearing seat is thus covered by the height-adjustable support 28.

The guide rail 40 comprises a fastening portion 40.1 designed as a rail foot, for example, and a guide portion 40.2, the guide portion 40.2 being arranged on the fastening portion 40.1. The height-adjustable support 28 has a guide device 60 for guiding the height-adjustable support 28 as it moves between a rest position and an active position of the lifting device 24, the guide device 60 engaging in the guide portion 40.2 of the guide rail 40. Moreover, the bearing seat 26 can also have a guide device 60 of this kind in order to ensure that the bearing seat 26 and therefore the lifting device 24 are stably seated on the guide rail 40.

FIG. 5 shows an enlarged detail B, indicated in FIG. 3, of the lifting device 24 in its active position and in particular a detail of the height-adjustable support 28. The support 28 has an opening groove 56.1, into which opening groove 56.1 a guide element 55.1 arranged on the support arm 30.1 engages, the illustration of the lifting device 24 shown in FIG. 5 corresponding to its active position. Moreover, the activation element 52.1 designed as a spring is arranged on the support arm 30.1. The opening groove 56.1 has a recess 59 which causes the support arm 30.1 to snap into position in accordance with the active position of the lifting device 24. A recess 59 of this kind prevents the lifting device 24 from being moved out of its active position into its rest position in an uncontrolled manner.

In accordance with the provisions of the patent statutes, the present invention has been described in what is considered to represent its preferred embodiment. However, it should be noted that the invention can be practiced otherwise than as specifically illustrated and described without departing from its spirit or scope.

1-7. (canceled)

8. An elevator system including an elevator shaft, an elevator car coupled to a counterweight, the elevator car and the counterweight being arranged in the elevator shaft so as to be movable in opposite directions, and a buffer device arranged in a shaft pit of the elevator shaft, wherein the buffer device limits a travel path of the counterweight, the buffer device comprising:
a buffer;
a lifting device arranged between the buffer and the counterweight, the lifting device having a rest position permitting overtravel of the elevator car in a shaft head of the elevator shaft; and
wherein the lifting device, when activated, transfers from the rest position to an active position restricting a travel path of the counterweight in the shaft pit thereby ensuring a minimum distance for maintenance by personnel between a shaft ceiling of the elevator shaft and the elevator car.

9. The elevator system according to claim 8 wherein the lifting device has a bearing seat positioned on the buffer and a height-adjustable support connected to the bearing seat.

10. The elevator system according to claim 9 including at least one guide rail for guiding the counterweight in the elevator shaft, wherein the support has a guide device guiding the support on the guide rail.

11. The elevator system according to claim 9 wherein the bearing seat and the support are connected by at least one support arm.

12. The elevator system according to claim 11 wherein the lifting device includes an activation element connected to the at least one support arm, the activation element causing the lifting device to move from the rest position into the active position.

13. The elevator system according to claim 12 wherein the activation element is connected to at least one of the bearing seat, the support and a further activation element.

14. The elevator system according to claim 12 wherein the activation element is formed as a spring.

15. An elevator system including an elevator shaft, an elevator car coupled to a counterweight, the elevator car and the counterweight being arranged in the elevator shaft so as to be movable in opposite directions, and a buffer device arranged in a shaft pit of the elevator shaft, wherein the buffer device limits a travel path of the counterweight, the buffer device comprising:
a buffer;
a lifting device arranged between the buffer and the counterweight, the lifting device having a rest position permitting overtravel of the elevator car in a shaft head of the elevator shaft, and wherein the lifting device, when activated, transfers from the rest position to an active position restricting a travel path of the counterweight in the shaft pit thereby ensuring a minimum distance for maintenance by personnel between a shaft ceiling of the elevator shaft and the elevator car;
wherein the lifting device has a bearing seat positioned on the buffer and a height-adjustable support connected to the bearing seat by at least one support arm; and
wherein the lifting device includes an activation element connected to the at least one support arm, the activation element causing the lifting device to move from the rest position into the active position.

16. The elevator system according to claim 15 wherein the activation element is connected to at least one of the bearing seat, the support and a further activation element.

17. The elevator system according to claim 15 wherein the activation element is formed as a spring.

18. The elevator system according to claim 15 including at least one guide rail for guiding the counterweight in the elevator shaft, wherein the support has a guide device guiding the support on the guide rail.
